(19) United States
(12) Patent Application Publication
(10) Pub. No.: US 2004/0030636 A1
(43) Pub. Date: Feb. 12, 2004

(54) Method of exchanging articles of commerce

(76) Inventor: Adam Sommer, New York, NY (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/635,624

(22) Filed: Aug. 6, 2003

Related U.S. Application Data
(60) Provisional application No. 60/401,975, filed on Aug. 8, 2002.

(51) Int. Cl. G06F 17/60

(52) U.S. Cl. 705/37

(57) ABSTRACT

A device for and method of exchanging articles of commerce.

### CROSS-REFERENCE TO RELATED APPLICATION

This application claims priority to U.S. Provisional Application Serial No. 60/401,975, filed Aug. 8, 2002, which is expressly incorporated herein by reference.

### BACKGROUND AND SUMMARY OF THE INVENTION

The present invention relates generally to a method of exchanging items. More particularly, the present invention relates to method of online stock and commodity exchanging.

Stocks, bonds, and commodities are typically exchanged in exchanges such as the New York Stock Exchange, NASDAQ, AMEX, New York Mercantile Exchange, and the like. In such exchanges, market makers accept bids to buy items and “asks” to sell items. The market makers subsequently match up compatible buyers and sellers and exchange an article of commerce for currency. Investors access these exchanges through a broker. Investors can access brokers directly, through another intermediary that employs the broker, and as is becoming increasingly popular, through a world wide web interface such as AMERTRADE, E-TRADE, DATEK, and the like. Each of these services typically charges a fee to complete the transaction such as a flat fee, a percentage-based fee, or otherwise.

In the event that an individual owning of an article of commerce, such as a particular stock, wishes to sell his stock and then buy another stock, a two step process is required. First, the individual submits his order to sell a quantity of stock either at the market price or at a specific price, and the broker charges a fee for facilitating the transaction. Second the individual submits an offer or order to buy a quantity of second stock for the market price or a set price. Again the broker charges a fee for facilitating the transaction.

According to a first embodiment of the present invention a method of exchanging articles of commerce is disclosed. The method includes the steps of accessing of an exchange system by a first user; offering, by the first user, a first amount of a first article of commerce in trade for a second amount of a second article of commerce; storing of the offer of the first user by the exchange system; accessing of the exchange system by a second user; searching of the exchange system by the second user; accepting the offer of the first user by the second user; transferring ownership of the first amount of the first article of commerce to the second user; and transferring ownership of the second amount of the second article of commerce to the first user.

According to another embodiment of the present invention, a method of exchanging articles of commerce is disclosed. The method includes the steps of: permitting a first user to electronically submit an offer of a first amount of a first article of commerce in trade for a second amount of a second article of commerce, wherein the first amount of the first article of commerce is held in an escrow account associated with the first user; permitting a second user to search through a plurality of offers, and permitting the second user to electronically accept the offer of the first user, wherein the second amount of the second article of commerce is held in an escrow account associated with the second user.

According to still another embodiment of the present invention, a method of exchanging articles of commerce is provided. The method includes the steps of: permitting a first user to electronically offer a first amount of a first article of commerce in trade for a second amount of a second article of commerce wherein the first user has the first amount of the first article of commerce held in an escrow account; and permitting a second user to view the offer of the first user.

According to another embodiment of the present invention, a method of exchanging articles of commerce is disclosed. The method includes the steps of: permitting a first user to offer a first amount of a first article of commerce in trade for a second amount of a second article of commerce, wherein the first user has the first amount of the first article of commerce in an escrow account; storing the offer of the first user in a database; and permitting a second user to search the database.

According to yet another embodiment of the present invention, a method of exchanging articles of commerce is provided. The method includes the steps of: listing an offer of a first amount of a first article of commerce in trade for a second amount of a second article of commerce, wherein the first user has the first amount of the first article of commerce in an escrow account; and allowing a user to accept the listed offer.

According to another embodiment of the present invention, an exchange system is disclosed. The system comprises means for allowing a first user to offer a first amount of a first article of commerce in trade for a second amount of a second article of commerce, wherein the first user has the first amount of the first article of commerce in an escrow account; and means for allowing a second user to accept the offer of the first user.

According to another embodiment of the present invention, an exchange system is disclosed. The system comprises an offer-storing database, the database being configured to store offers to trade amounts of articles of commerce for amounts of other articles of commerce, the articles of commerce being held in escrow accounts and the offers being selectable by a second user.

According to another embodiment of the present invention, a method in a computer system for exchanging articles of commerce is disclosed. The method comprises the steps of: receiving, over a communication network from a first client, a transmission of an offer to exchange a first amount of a first article of commerce for a second amount of a second article of commerce, the first client having the first amount of the first article of commerce in a first escrow account; storing the offer; permitting the offer to be communicated to a second client; and receiving, over the communication network from the second client, a transmission of an acceptance of the offer, the second client having the second amount of the second article of commerce in a second escrow account.

According to another embodiment of the present invention, a method of exchanging articles of commerce is provided. The method includes the steps of: permitting a first user to offer a first amount of a first article of commerce in trade for a second amount of a second article of commerce; permitting a second user to offer a third amount of the second article of commerce for a fourth amount of the first article of commerce; verifying that the first amount of the first article of commerce is equal to or larger than the fourth amount of the first article; verifying that the third amount of the second article is equal to or greater than the second amount of the second article; providing for the execution of a trade.

According to another embodiment of the present invention, a method of exchanging articles of commerce is disclosed. The method includes the steps of: accessing of an exchange system by a first user; and offering, by the first user, a first amount of a first article of commerce contained in an escrow account in trade for a second amount of a second article of commerce, wherein the exchange system permits a second user to accept the offer of the first user provided that the second user has the second amount of the second article of commerce contained in an escrow account.

According to another embodiment of the present invention, a method of exchanging articles of commerce is disclosed. The method includes the steps of: accessing of an exchange system by a second user; viewing offers from users including an offer from a first user to exchange a first amount of a first article of commerce for a second amount of a second article of commerce; and accepting an offer, wherein the second user has the second amount of the second article of commerce in an escrow account.

According to another embodiment of the present invention, a method of exchanging articles of commerce is disclosed. The method includes the steps of: receiving articles of commerce; and providing for the articles of commerce to be associated with a first user, wherein the first user is permitted to trade the articles of commerce with other users of an exchange system that choose to trade with the first user.

According to another embodiment of the present invention, a method of exchanging articles of commerce is disclosed. The method includes the steps of: transmitting a first communication of a first user, the communication offering to trade a first amount of a first article of commerce contained in an escrow account for a second amount of a second article of commerce; transmitting a listing of offers; and transmitting a second communication of a second user, the second communication accepting the offer of the first user.

According to another embodiment of the present invention, a method of exchanging non-currency articles of commerce is disclosed. The method includes the steps of: permitting a first user to electronically submit an offer of a first amount of a first non-currency article of commerce in trade for a second amount of a second non-currency article of commerce; and permitting a second user to electronically accept the offer of the first user.

According to another embodiment of the present invention, a method of exchanging non-currency articles of commerce is disclosed. The method includes the steps of: permitting a first user to electronically offer a first amount of a first non-currency article of commerce in trade for a second amount of a second non-currency article of commerce; and permitting a second user to view the offer of the first user.

According to another embodiment of the present invention, a method of exchanging non-currency articles of commerce is disclosed. The method includes the steps of: permitting a first user to offer a first amount of a first non-currency article of commerce in trade for a second amount of a second non-currency article of commerce; storing the offer of the first user in a database; and permitting a second user to search the database.

According to another embodiment of the present invention, a method of exchanging non-currency articles of commerce is disclosed. The method includes the steps of: listing of an offer of a first amount of a first non-currency article of commerce in trade for a second amount of a second non-currency article of commerce; and allowing a user to accept the listed offer.

According to another embodiment of the present invention, an exchange system is disclosed. The exchange system comprises means for allowing a first user to offer a first amount of a first non-currency article of commerce in trade for a second amount of a second non-currency article of commerce; and means for allowing a second user to accept the offer of the first user.

According to another embodiment of the present invention, an exchange system is disclosed. The exchange system comprises an offer-storing database, the database being configured to store offers to trade amounts of non-currency articles of commerce for amounts of other non-currency articles of commerce, the offers being selectable by a second user.

According to another embodiment of the present invention, a method in a computer system for exchanging non-currency articles of commerce is disclosed. The method comprises the steps of: receiving, over a communication network from a first client, a transmission of an offer to exchange a first amount of a first non-currency article of commerce for a second amount of a second non-currency article of commerce; storing the offer; permitting the offer to be communicated to a second client; and receiving, over the communication network from the second client, a transmission of an acceptance of the offer.

According to another embodiment of the present invention, a method in a computer system for exchanging non-currency articles of commerce is disclosed. The method comprising the steps of: receiving, over a communication network from a first client, a transmission of an offer to exchange a first amount of a first non-currency article of commerce for a second amount of a second non-currency article of commerce; receiving, over a communication network from a second client, a transmission of an offer to exchange the second amount of the second non-currency article of commerce for the first amount of the first non-currency article of commerce; matching the offer of the first client with the offer of the second client; and providing for performance of the exchange.

According to another embodiment of the present invention, a method of exchanging non-currency articles of commerce is disclosed. The method includes the steps of: allowing a first user to offer a first amount of a first non-currency article of commerce in trade for a second amount of a second non-currency article of commerce; allowing a second user to offer the second amount of the second non-currency article of commerce in trade for the first amount of the first non-currency article of commerce; and exchanging the first amount of the first non-currency article of commerce and the second amount of the second non-currency article of commerce between the first user and second user.

According to another embodiment of the present invention, a method of exchanging non-currency articles of commerce is disclosed. The method includes the steps of: permitting a first user to offer a first amount of a first non-currency article of commerce in trade for a second amount of a second non-currency article of commerce; permitting a second user to offer a third amount of the second non-currency article of commerce for a fourth amount of the first non-currency article of commerce; verifying that the first amount of the first non-currency article of commerce is equal to or larger than the fourth amount of the first non-currency article of commerce; verifying that the third amount of the second non-currency article is equal to or greater than the second amount of the second non-currency article; and providing for the execution of a trade.

According to another embodiment of the present invention, a method of exchanging non-currency articles of commerce is disclosed. The method includes the steps of: accessing of an exchange system by a first user; and offering, by the first user, a first amount of a first non-currency article of commerce in trade for a second amount of a second non-currency article of commerce, wherein the exchange system permits a second user to accept the offer of the first user.

According to another embodiment of the present invention, a method of exchanging non-currency articles of commerce is disclosed. The method includes the steps of: accessing of an exchange system by a second user; viewing offers from a first user to exchange a first amount of a first non-currency article of commerce for a second amount of a second non-currency article of commerce; and accepting an offer.

According to another embodiment of the present invention, a method of exchanging non-currency articles of commerce is disclosed. The method includes the steps of: receiving non-currency articles of commerce; and providing for the non-currency articles of commerce to be associated with a first user, wherein the first user is permitted to trade the non-currency articles of commerce with other users of an exchange system.

According to another embodiment of the present invention, a method of exchanging non-currency articles of commerce is disclosed. The method includes the steps of: transmitting a first communication of a first user, the communication offering to trade a first amount of a first non-currency article of commerce for a second amount of a second non-currency article of commerce; transmitting a listing of offers; and transmitting a second communication of a second user, the second communication accepting the offer of the first user.

Additional features of the invention will become apparent to those skilled in the art upon consideration of the following detailed description of the presently perceived best mode of carrying out the invention.

### BRIEF DESCRIPTION OF THE DRAWINGS

The detailed description particularly refers to the accompanying figures in which:

FIG. 1 is a diagram of an exchange system according to the present disclosure;

FIG. 2 is a view of a user search interface for the exchange system of FIG. 1;

FIG. 3 is a view of a listing of offers for trade generated by using the search interface of FIG. 2; and

FIG. 4 is a view of an offer interface for the system of FIG. 1.

### DETAILED DESCRIPTION OF THE DRAWINGS

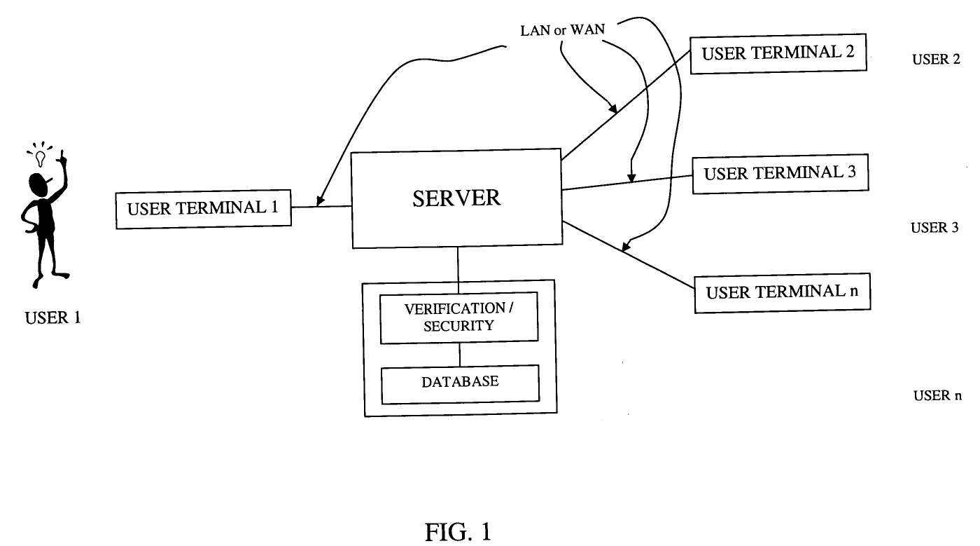

A system of exchange 10 according to the present disclosure is shown generally in FIG. 1. Exchange 10 is configured to permit two owners of stock or other tradable items to directly trade such items with each other over a distributed network.

The system 10 includes a plurality of user terminals 12, 14, 16, 18, a server 20, and a central computer 22. The designation “N” of user terminal 18 indicates that the total number of user terminals which could be utilized by the system 10 may be any desired number and may fluctuate as users log on and log off of the exchange 10. The user terminals 12, 14, 16, 18 may include personal computers, network capable PDA's, wireless web-capable phones, other smart terminals, dumb terminals, or any other devices capable of communicating over a network 24 (a local area network, LAN, or a wide area network, WAN) or other communications means known to those of ordinary skill in the art for accepting input and/or displaying information to the user. Preferably, the central computer 22 houses a processor (not shown), verification/security software 26, and a database 28. According to alternative embodiments of the present disclosure, the processor, software, and database are decentralized.

The database 28 is capable of receiving offers to trade one or more articles of commerce for another article or articles of commerce. The articles of commerce may include any items which are exchanged for other items of value. Articles of commerce are items such as stock shares, options, commodities, futures, currencies, and other items known to those of ordinary skill in the art. Offers to trade come from users operating user terminals 12, 14, 16, 18. A storage device (not pictured) stores the offer database, and also stores information describing an escrow account for each user. Alternatively, the offer database and the account information can be stored on separate storage devices. Furthermore, as the size of both the offer database and the account information become large, it is likely that many linked storage devices will have to be used to store each of the offer database and account information.

In operation, a user signs on to a user terminal 12, 14, 16, 18 that either has local client software or access to a web-based or other application. Preferably, the client software or web-based application requires a logon If) and a password to positively identify the user and associate him with the account that has been set up with the exchange system 10. The user is associated with the account through the verification/security software 26 that provides encryption for the web/network communications. Once authenticated, the user is allowed to view his account, view the offer database 28, and contribute a new offer into the database 28 consistent with his account holdings.

The account of each user keeps an inventory of the articles of commerce associated with/owned by the user. The account is preferably an escrow account. The escrow account includes a listing of the articles of commerce that the user has submitted to the system owner or third party in trust. By utilizing the escrow account, the system can verify that the items actually exist, and the system can require compliance with transfers that are agreed to by the user. The user is allowed to post offers to trade articles of commerce in his account for other articles of commerce. The user may also search through offers made by other users and selectively accept an offer that he finds desirable and that is asking for an article of commerce he owns. A user may associate his account with a cash account, such as a bank account, money market account, PAYPAL account, or likewise and have transactions involving cash credited or debited to the associated accounts. Preferably, the system 10 is able to verify the contents of associated accounts and able to require withdrawals therefrom in conformance, as needed, with trades executed by the user. All associated articles are preferably able to be verified by the system 10 and can be controlled by the system 10 to ensure that articles in an accepted trade are in fact exchanged. The previously noted use of an escrow account achieves the verifiability, controllability, and ensurability of trade that is desired.

The system allows a first stock owner to offer up, in trade, a first number of shares of a first stock in his account. In formulating the offer, the first stock owner also declares a second number of shares of a second stock for which he is willing to trade his first number of shares of the first stock. A second authenticated user, associated with an account, may then peruse the listings of other users to find someone asking for a number of shares of stock the second user owns and offering an acceptable number of shares of the first stock or a third stock in return. In the event that the second user finds the first user's offer acceptable, the second user will accept the offer and the designated first and second shares will be traded between the first and second users, with the option of a fee being charged by the hosting service. In the event that the second user does not find a satisfactory offer, the second user may then post an offer of his own that is satisfactory to the second user.

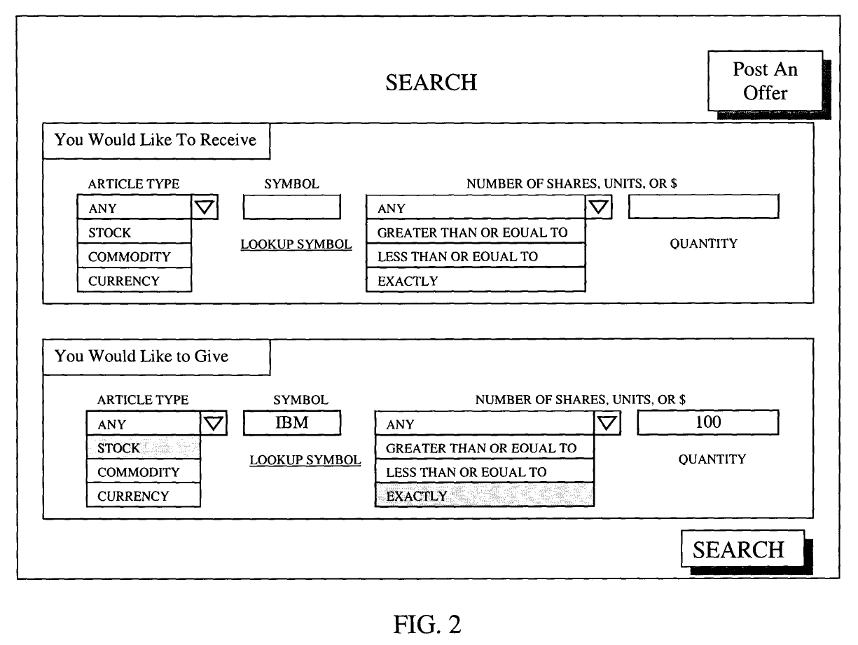

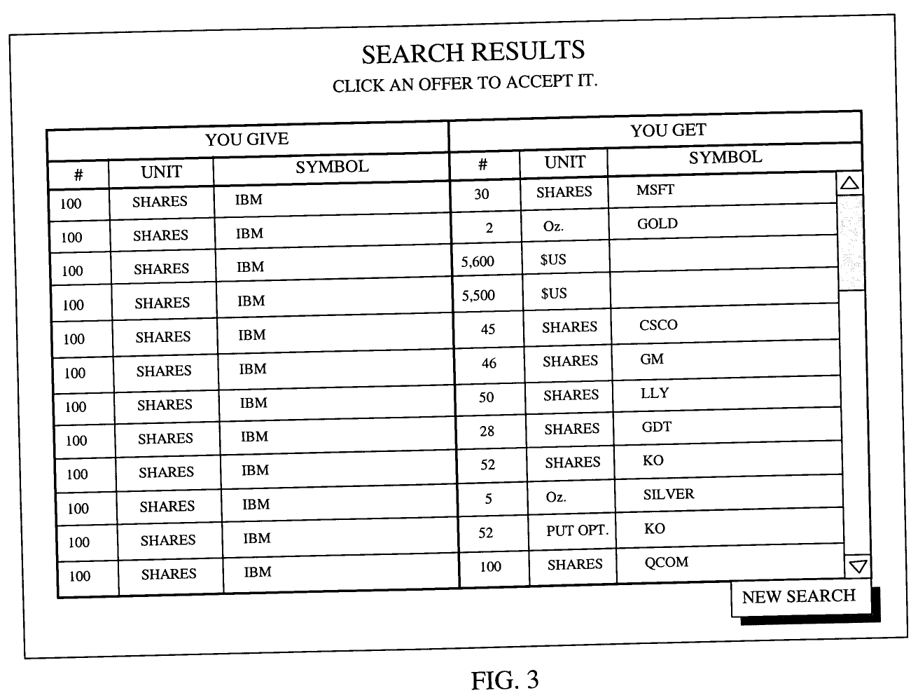

To aid in the location of suitable offers, the offers are electronically searchable by users. Offers are typically searched through the use of a search form as shown in FIG. 2. While the search form in FIG. 2 is exemplary, other interfaces may be provided that are configured to perform other desired searches including parameters known in the trading art to be useful. The searching user fills in any number of the fields to return results of varying specificity. The more fields that are filled in, the more specific and tailored the results returned are. FIG. 3 shows a typical result when the user inputs that he is willing to trade exactly 100 shares of IBM stock. The user then picks from the results and accepts any of the offers found to be acceptable. Preferably, the system may have a confirmation screen to ensure that an offer is not accepted in error. Upon acceptance, the system transfers the agreed upon articles of commerce between the accounts.

Furthermore, when a first user places an offer of items in his escrow account, the offered items are placed on hold. By placing the offered items on hold, the items are not available to be placed in another offer or to satisfy the acceptance of another user's offer. Placing the offered items on hold ensures that if the first user's offer is accepted, the offered items will be present in the escrow account to be transferred to the accepting party. However, the offer may be rescinded by the first user.

The first user may search for his own outstanding offers, or alternatively be provided with a listing of all of his outstanding offers. The system recognizes when the first user accesses his own offers, and provides a button or the like that the first user may push to rescind the offer. If the offering party rescinds the offer, the items are taken off hold and are available to be used to form another offer or to accept a pending offer from another user.

For all examples herein, assume:

User A has an escrow account containing $5000, 3000 shares of GM stock (General Motors), 5000 shares of KO stock (Coca-Cola), and 100 shares of IBM stock.

User B has an escrow account containing $10,000, 2000 shares of MSFT stock (Microsoft), and 12,000 shares of SUNW stock (Sun Microsystems).

An example transaction is as follows:

User A logs onto the system and decides that he wants to trade some of his KO stock and acquire SUNW stock. After searching the database of offers and finding no suitable offer, User A posts an offer to trade 1,000 shares of KO stock for 11,250 shares of SUNW stock. After inputting the offer, User A is taken to a confirmation screen to ensure that the input offer is the offer that User A intended to input.

User B logs onto the system and decides that he wants to trade some of his shares of SUNW stock. User B then inputs a search to the search interface of FIG. 2. User B inputs that he wants to offer less than or equal to 12,000 shares of SUNW because he only has 12,000 shares in his escrow account, and thus that is the maximum that he would be able to fill. By executing the search, the offer input by User A will show up provided that it has not been accepted by another user. User B, finding User A's offer acceptable, then selects the offer for acceptance. User B is then taken to a confirmation screen to ensure that the selected offer is the offer that User B intended to select.

Once confirmed, the system transfers 11,250 shares of SUNW stock from the escrow account of User B to the escrow account of User A. The system also transfers 1000 shares of KO stock from the escrow account of User A to the escrow account of User B. After the exchange, User B still has 750 shares of SUNW stock in his escrow account.

In a second example, User A logs onto the system and decides that he wants to buy some MSFT stock. After searching the database of offers and finding no suitable offer, User A posts an offer to buy 100 shares of MSFT stock for $4,600. After inputting the offer, User A is taken to a confirmation screen to ensure that the input offer is the offer that User A intended to input.

User B logs onto the system and decides that he wants to trade some of his shares of MSFT stock. User B then inputs a search to the search interface of FIG. 2. User B inputs that he wants to offer less than or equal to 2000 shares of MSFT because he only has 2000 shares in his escrow account, and thus that is the maximum that he would be able to fill. By executing the search, the offer input by User A will show up provided that it has not been accepted by another user. User B, finding User A's offer acceptable, then selects the offer for acceptance. User B is then taken to a confirmation screen to ensure that the selected offer is the offer that User B intended to select.

Once confirmed, the system transfers 100 shares of MSFT stock from the escrow account of User B to the escrow account of User A. The system also transfers $4,600 from the escrow account of User A to the escrow account of User B. Once the articles are transferred, the system sends a notification to both users. The notification informs of and confirms the transaction and states the terms of the transaction. After the transaction 1900 shares of MSFT remain in User B's escrow account and $400 remains in User A's escrow account.

Alternatively, offers can be made that mix different types of articles within the same offer. An example of such an offer would be if User A offers 300 shares of GM stock and $100 in exchange for 50 shares of MSFY.

The system 10 gives users the ability to effectively perform both buying one article and selling another article in one transaction, if they wish, thereby potentially reducing the fees (such as brokerage fees) that are associated with a buying and selling transaction. Alternatively to charging a fee per transaction, the service can be a subscription service. The subscription then gives subscribers access to the database of offers and the ability to post offers free of further charges for the duration of the subscription. Therefore, the user can buy and sell his articles for cash similar to traditional markets, except the offers he puts out will be searched and specifically selected by other users. Furthermore, under the subscription model, the user will not be charged a fee per purchase or sale he makes.

The system 10 also includes the ability to automatically match up matching offers. Rather than a second user searching through the offers, the second user may only want to input an offer of his own. The offer by the second user may in fact be a suitable match to an outstanding offer by a first user. In such a case, the system 10 recognizes the match, and executes the trade. The system 10 can likewise make matches on inexact matches where a first user is asking for a first amount in return, and a second user is offering more than the first amount in return, thus creating an overlap excess. The amount that is then exchanged can be set by the operator of the system to be the amount requested by the first user, the amount offered by the second user, or somewhere in between. Alternatively, the system can be set up to give the first user the amount he requested, and charge the second user the amount he offered, with the system taking the difference, overlap excess, as profit, as a fee for finding the match.

An example of where overlap excess is taken as profit is as follows:

User A offers 100 shares of IBM stock and asks for 20 shares of MSFT stock.

User B offers 25 shares of MSFT stock and asks for 100 shares of IBM stock.

In such a situation, the system 10 will transfer 100 shares of IBM from User A to User B, transfer 20 shares of MSFT from User B to User A, and take 5 shares of MSFT from User B into the system owner account. Thus, User A receives exactly what he asked for in exchange for exactly what he offered, 20 shares of MSFT for 100 shares of IBM. Likewise, User B receives exactly what he asked for, 100 shares of IBM, for exactly what he offered, 25 shares of MSFT. This can be performed as shown above by a single trade with the system 10 taking the excess overlap. Alternatively, this can be performed by the system 10 accepting both offers on behalf of itself, thus again netting itself the 5 shares of MSFT. It should be appreciated that while the forgoing example involved specific stocks, it could be applied to any articles of commerce and offers involving excess overlap.

In another embodiment of the present disclosure, the offers of different users are not searchable by the users. In such an embodiment, offers are made by the users, and the system 10 matches them as described above. In such an embodiment, the transactions could be completed at no charge to the users, meaning no subscription or per transaction costs, with the system 10 making its profit only through the overlap excess profit taking. However, a subscription or per transaction fee could still be charged if desired by the system administrator.

The system 10 continues collecting odd lots of excess overlap articles of commerce in the searchable embodiment or the non-searchable embodiment. The system 10 can then, illustratively, wait until it accumulates 100 shares of MSFT, and then fill an offer by a user to trade currency for 100 shares of MSFT, provided the amount of currency offered is above a threshold level set by the system 10 administrator, or the system 10 can post an offer to trade the accumulated 100 shares for currency. Alternatively, the system 10 can check the current price of the accumulated article on the traditional markets, NYSE, AMEX, etc. and automatically thereby set the threshold level or the offer price, thus requiring less administrator intervention and making the system profit less subject to market volatility by transferring assets to currency quicker. As the system 10 gains more users, and thus more offers, the likelihood of such overlap excess is diminished in that it is more likely for a user to be able to find an exact match for his desired offer.

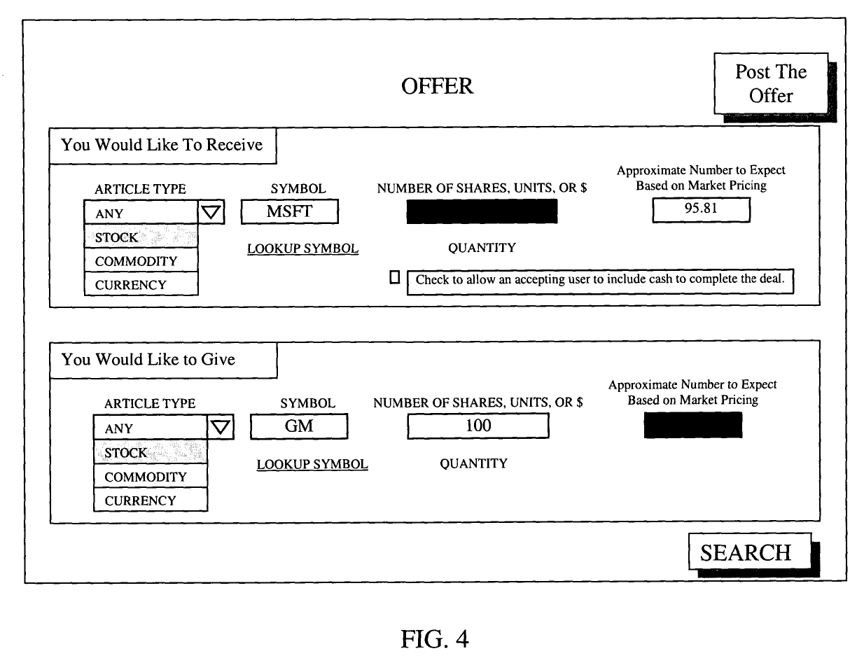

Also envisioned are embodiments where offers do not specify both the offering and receiving amounts of articles of commerce but rather rely on the traditional market price to define one of the amounts. In such an embodiment, an offer would be created using a form similar to the form in FIG. 4. The offering first user specifies both the offering article of commerce and the receiving article of commerce, but then only specifies the quantity of one of the articles. As seen in FIG. 4, the offering user specifies the amount of 100 shares of GM to be offered for shares of MSFT. The number of shares he is to get in return is determined by the pricing of each of the stocks on the NYSE or equivalent exchange. The offering user can also specify whether an accepting user may make up any deficiency in shares with cash equivalent. After the offer of FIG. 4 is placed, the system checks the current fair market value of GM, as determined by the NYSE that, for example, is $43.04 per share. Therefore, 100 shares are worth $4304. The system then checks the price of MSFT to find that it is, for example, $44.92 per share. The system then divides $4304, the value of 100 shares of GM, by $44.92, the price per MSFT share, to get 95.81 shares. Therefore, the offer will show up as 100 shares of GM for 96 shares of MSFT. The offer will be constantly updated as the prices of the stocks fluctuate. Alternatively, it could round down the shares of what the offer requires (to 95 shares). In another alternative embodiment, the offer asks for 95 shares of MSFT and the cash equivalent of 0.81 shares. In still another embodiment, the accepting user could be charged 96 shares of the MSFT and the offering user could receive 95 shares of MSFT with the system retaining one share similarly to the overlap excess examples.

When the offer is placed with the offering user checking to allow an accepting user to make up any deficiency in shares with cash equivalent, the accepting user need not have the full amount of requesting shares. When the cash equivalent is allowed, a user who has 50 shares of MSFT and the cash equivalent of 45.81 shares can accept the offer for the 100 shares of GM. This could be then taken to the extreme to allow a straight cash for stock exchange, however this still is advantageous over current markets in that it is a person to person exchange and not over the traditional markets through a market maker who would charge a fee.

Furthermore, if the accepting user does not have the required cash in his account, an outside escrow service, such as PAYPAL, that accepts credit card deposits and then transfers cash may be utilized to get the required cash into the account and complete the trade.

While the embodiment above has been described with an offer stating the number of shares to offer and having the receiving amount determined by the market price, the offer could be formed by positively stating the number of shares to be received and letting the offering amount of shares be determined by the market price. In all examples, the system will preferably verify that both parties in fact have the required amounts in their accounts. More specifically, in the case where the receiving amount is specified and the offering amount is determined by the market price, the system will remove the offer from the system in the event that the market dictates an amount of an article of commerce that the offering party does not have.

It is also disclosed that certain tax advantages may be available to users by using the exchange system and method described above. It is also disclosed that in certain embodiments stockowners may not directly access the system, but rather brokers or the like will actually input the offers and make the acceptances on behalf of stockowners, i.e. first and second users.

Although the invention has been described in detail with reference to certain preferred embodiments, variations and modifications exist within the scope and spirit of the present invention as described and defined in the following claims.

1. A method of exchanging articles of commerce including the steps of:
accessing of an exchange system by a first user;
offering, by the first user, a first amount of a first article of commerce in trade for a second amount of a second article of commerce;
storing of the offer of the first user by the exchange system;
accessing of the exchange system by a second user;
searching of the exchange system by the second user;
accepting the offer of the first user by the second user;
transferring ownership of the first amount of the first article of commerce to the second user; and
transferring ownership of the second amount of the second article of commerce to the first user.

2. The method of claim 1, wherein the first accessing step further includes the steps of authenticating the first user and associating the first user with a first system account and the second accessing step further includes the steps of authenticating the second user and associating the second user with a second system account.

3. The method of claim 2, wherein the system accounts are escrow accounts.

4. The method of claim 1, wherein the exchange system is utilized over a network.

5. The method of claim 1, wherein the storing step uses a database to store the offer.

6. The method of claim 5, wherein the searching step includes the second user searching the database.

7. The method of claim 1, wherein the first transferring step includes transferring the first amount of the first article of commerce from an escrow account of the first user to an escrow account of the second user and the second transferring step includes transferring the second amount of the second article of commerce from an escrow account of the second user to the escrow account of the first user.

8. The method of claim 1, wherein a fee is charged to allow the first user to use the exchange system.

9. A method of exchanging articles of commerce including the steps of:
permitting a first user to electronically submit an offer of a first amount of a first article of commerce in trade for a second amount of a second article of commerce, wherein the first amount of the first article of commerce is held in an escrow account associated with the first user;
permitting a second user to search through a plurality of offers, and
permitting the second user to electronically accept the offer of the first user, wherein the second amount of the second article of commerce is held in an escrow account associated with the second user.

10. The method of claim 9, wherein the first permitting step includes the step of providing for verifying that the first user has the first amount of the first article of commerce in the escrow account associated with the first user.

11. The method of claim 9, wherein the second permitting step includes the step of providing for transferring the first amount of the first article of commerce to the escrow account of the second user.

12. The method of claim 9, wherein the second permitting step includes the step of providing for verifying that the second user has the second amount of the second article of commerce in the escrow account associated with the second user.

13. The method of claim 9, wherein the second permitting step includes the step of providing for transferring the second amount of the second article of commerce to the escrow account of the first user.

14. A method of exchanging articles of commerce including the steps of:
permitting a first user to electronically offer a first amount of a first article of commerce in trade for a second amount of a second article of commerce wherein the first user has the first amount of the first article of commerce held in an escrow account; and
permitting a second user to view the offer of the first user.

15. The method of claim 14, further including the step of permitting the second user to accept the offer of the first user.

16. The method of claim 15, further including the step of permitting, upon the second user accepting the offer of the first user, an exchange of the first amount of the first article of commerce for the second amount of the second article of commerce.

17. A method of exchanging articles of commerce including the steps of:
permitting a first user to offer a first amount of a first article of commerce in trade for a second amount of a second article of commerce, wherein the first user has the first amount of the first article of commerce in an escrow account;
storing the offer of the first user in a database; and
permitting a second user to search the database.

18. The method of claim 17, further including the step of permitting the second user to accept an offer in the database.

19. The method of claim 18, further including the step of removing an offer from the database in response to the offer being accepted.

20. The method of claim 17, wherein the first amount of the first article of commerce is placed on hold within the account of the first user for the duration of the offer.

21. The method of claim 20, wherein the first amount of the first article of commerce that is on hold is transferred to a second user upon acceptance of the offer by the second user.

22. A method of exchanging articles of commerce including the steps of:
listing an offer of a first amount of a first article of commerce in trade for a second amount of a second article of commerce, wherein the first user has the first amount of the first article of commerce in an escrow account; and
allowing a user to accept the listed offer.

23. The method of claim 22, wherein the listed offers are stored in a database.

24. The method of claim 23, wherein the user is able to search the database of offers.

25. An exchange system comprising:
means for allowing a first user to offer a first amount of a first article of commerce in trade for a second amount of a second article of commerce, wherein the first user has the first amount of the first article of commerce in an escrow account; and
means for allowing a second user to accept the offer of the first user.

26. The system of claim 25, wherein the allowing to offer means includes a database to store the offer of the first user.

27. The system of claim 25, wherein the allowing to offer means includes computer software.

28. The system of claim 25, wherein the allowing to accept means includes computer software.

29. The system of claim 25, further comprising means for allowing ownership of the first amount of the first article of commerce to be transferred to the second user and for ownership of the second amount of the second article of commerce to be transferred to the first user.

30. An exchange system comprising an offer-storing database, the database being configured to store offers to trade amounts of articles of commerce for amounts of other articles of commerce, the articles of commerce being held in escrow accounts and the offers being selectable by a second user.

31. The exchange system of claim 30, wherein offers selected by the second user can then be accepted by the second user.

32. The exchange system of claim 31, wherein the accepted offers are removed from the offer-storing database.

33. The exchange system of claim 30, wherein the offers stored in the database are created by a first user.

34. The exchange system of claim 33, wherein the first user is associated with an escrow account containing the articles that the first user is offering to trade.

35. A method in a computer system for exchanging articles of commerce, the method comprising the steps of:
receiving, over a communication network from a first client, a transmission of an offer to exchange a first amount of a first article of commerce for a second amount of a second article of commerce, the first client having the first amount of the first article of commerce in a first escrow account;
storing the offer;
permitting the offer to be communicated to a second client; and
receiving, over the communication network from the second client, a transmission of an acceptance of the offer, the second client having the second amount of the second article of commerce in a second escrow account.

36. The method of claim 35, wherein, upon completion of the receiving an acceptance step, the system transfers articles from the first account to the second account and from the second account to the first account.

37. A method of exchanging articles of commerce including the steps of:
permitting a first user to offer a first amount of a first article of commerce in trade for a second amount of a second article of commerce;
permitting a second user to offer a third amount of the second article of commerce for a fourth amount of the first article of commerce;
verifying that the first amount of the first article of commerce is equal to or larger than the fourth amount of the first article;
verifying that the third amount of the second article is equal to or greater than the second amount of the second article; and
providing for the execution of a trade.

38. The system of claim 37, wherein the provided for trade results in the first user receiving the second amount of the second article of commerce, the second user receiving the fourth amount of the first article of commerce, and the system retaining any difference between the first and fourth amounts of the first article of commerce and any difference between the second and third amounts of the second article of commerce.

39. The system of claim 38, further comprising the step of providing for issuance of a notice of the executed trade to the first user and to the second user.

40. A method of exchanging articles of commerce including the steps of:
accessing of an exchange system by a first user; and
offering, by the first user, a first amount of a first article of commerce contained in an escrow account in trade for a second amount of a second article of commerce, wherein the exchange system permits a second user to accept the offer of the first user provided that the second user has the second amount of the second article of commerce contained in an escrow account.

41. The method of claim 40, wherein the offers are searchable by the second user.

42. The method of claim 40, wherein the offers are stored on a database.

43. The method of claim 40, wherein the accessing step is performed over a network.

44. A method of exchanging articles of commerce including the steps of:
accessing of an exchange system by a second user;
viewing offers from users including an offer from a first user to exchange a first amount of a first article of commerce for a second amount of a second article of commerce; and
accepting an offer, wherein the second user has the second amount of the second article of commerce in an escrow account.

45. The method of claim 44, wherein the offers are stored in a database.

46. The method of claim 44, wherein the accessing step is performed over a network.

47. The method of claim 44, wherein the first user and the second user each have escrow accounts with the exchange system.

48. The method of claim 44, wherein the offer of the first user is removed from the system when the offer is accepted by the second user.

49. A method of exchanging articles of commerce including the steps of:
receiving articles of commerce; and
providing for the articles of commerce to be associated with a first user, wherein the first user is permitted to trade the articles of commerce with other users of an exchange system that choose to trade with the first user.

50. The method of claim 49, wherein the providing step includes associating the articles of commerce with an escrow account.

51. The method of claim 49, wherein the providing step includes forwarding the received articles to another location.

52. The method of claim 49, wherein a record of the received articles is maintained by the exchange system.

53. A method of exchanging articles of commerce including the steps of:
transmitting a first communication of a first user, the communication offering to trade a first amount of a first article of commerce contained in an escrow account for a second amount of a second article of commerce;
transmitting a listing of offers; and
transmitting a second communication of a second user, the second communication accepting the offer of the first user.

54. The method of claim 53, further including the step of transmitting confirmation of the trade.

55. The method of claim 53, further including the steps of transmitting a third communication to identify the first user; and transmitting a fourth communication to identify the second user.

56. The method of claim 55, wherein the third communication associates the first user with the escrow account and the fourth communication associates the second user with an escrow account.

57. A method of exchanging non-currency articles of commerce including the steps of:
permitting a first user to electronically submit an offer of a first amount of a first non-currency article of commerce in trade for a second amount of a second non-currency article of commerce; and
permitting a second user to electronically accept the offer of the first user.

58. The method of claim 57, wherein the first permitting step includes the step of providing for verifying that the first user has the first amount of the first non-currency article of commerce in an escrow account associated with the first user.

59. The method of claim 57, wherein the second permitting step includes the step of providing for transferring the first amount of the first non-currency article of commerce to an escrow account of the second user.

60. The method of claim 57, wherein the second permitting step includes the step of providing for verifying that the second user has the second amount of the second non-currency article of commerce in an escrow account associated with the second user.

61. The method of claim 57, wherein the second permitting step includes the step of providing for transferring the second amount of the second non-currency article of commerce to an escrow account of the first user.

62. A method of exchanging non-currency articles of commerce including the steps of:
permitting a first user to electronically offer a first amount of a first non-currency article of commerce in trade for a second amount of a second non-currency article of commerce; and
permitting a second user to view the offer of the first user.

63. The method of claim 62, further including the step of permitting the second user to accept the offer of the first user.

64. The method of claim 62, further including the step of permitting, upon the second user accepting the offer of the first user, an exchange of the first amount of the first non-currency article of commerce for the second amount of the second non-currency article of commerce.

65. A method of exchanging non-currency articles of commerce including the steps of:
permitting a first user to offer a first amount of a first non-currency article of commerce in trade for a second amount of a second non-currency article of commerce;
storing the offer of the first user in a database; and
permitting a second user to search the database.

66. The method of claim 65, further including the step of permitting the second user to accept an offer in the database.

67. The method of claim 65, further including the step of removing an offer from the database in response to the offer being accepted.

68. The method of claim 65, wherein the first amount of the first non-currency article of commerce is placed on hold within an account of the first user for the duration of the offer.

69. The method of claim 65, wherein the first amount of the first non-currency article of commerce that is on hold is transferred to a second user upon acceptance of the offer by the second user.

70. A method of exchanging non-currency articles of commerce including the steps of:
listing of an offer of a first amount of a first non-currency article of commerce in trade for a second amount of a second non-currency article of commerce; and
allowing a user to accept the listed offer.

71. The method of claim 70, wherein the listed offers are stored in a database.

72. The method of claim 70, wherein the user is able to search the database of offers.

73. An exchange system comprising:
means for allowing a first user to offer a first amount of a first non-currency article of commerce in trade for a second amount of a second non-currency article of commerce; and
means for allowing a second user to accept the offer of the first user.

74. The system of claim 73, wherein the allowing to offer means includes a database to store the offer of the first user.

75. The system of claim 73, wherein the allowing to offer means includes computer software.

76. The system of claim 74, wherein the allowing to accept means includes computer software.

77. The system of claim 74, further comprising means for allowing ownership of the first amount of the first non-currency article of commerce to be transferred to the second user and for ownership of the second non-currency amount of the second article of commerce to be transferred to the first user.

78. An exchange system comprising an offer-storing database, the database being configured to store offers to trade amounts of non-currency articles of commerce for amounts of other non-currency articles of commerce, the offers being selectable by a second user.

79. The exchange system of claim 78, wherein offers selected by the second user can then be accepted by the second user.

80. The exchange system of claim 79, wherein the accepted offers are removed from the offer-storing database.

81. The exchange system of claim 78, wherein the offers stored in the database are created by a first user.

82. The exchange system of claim 81, wherein the first user is associated with an account containing the non-currency articles that the first user is offering to trade.

83. A method in a computer system for exchanging non-currency articles of commerce, the method comprising the steps of:
receiving, over a communication network from a first client, a transmission of an offer to exchange a first amount of a first non-currency article of commerce for a second amount of a second non-currency article of commerce;
storing the offer;
permitting the offer to be communicated to a second client; and
receiving, over the communication network from the second client, a transmission of an acceptance of the offer.

84. The method of claim 83, wherein the first client is associated with a first account and the second client is associated with a second account.

85. The method of claim 84, wherein, upon completion of the receiving an acceptance step, the system transfers non-currency articles from the first account to the second account and from the second account to the first account.

86. A method in a computer system for exchanging non-currency articles of commerce, the method comprising the steps of:
receiving, over a communication network from a first client, a transmission of an offer to exchange a first amount of a first non-currency article of commerce for a second amount of a second non-currency article of commerce;
receiving, over a communication network from a second client, a transmission of an offer to exchange the second amount of the second non-currency article of commerce for the first amount of the first non-currency article of commerce;
matching the offer of the first client with the offer of the second client; and
providing for performance of the exchange.

87. The method of claim 86, further comprising the step of providing for notifying the first user and the second user of the exchange.

88. The method of claim 86, further comprising the step of providing for verifying that the first amount of the first non-currency article of commerce is available to be traded.

89. The method of claim 86, further comprising the step of providing for verifying that the second amount of the second non-currency article of commerce is available to be traded.

90. A method of exchanging non-currency articles of commerce including the steps of:
allowing a first user to offer a first amount of a first non-currency article of commerce in trade for a second amount of a second non-currency article of commerce;
allowing a second user to offer the second amount of the second non-currency article of commerce in trade for the first amount of the first non-currency article of commerce; and
exchanging the first amount of the first non-currency article of commerce and the second amount of the second non-currency article of commerce between the first user and second user.

91. The method of claim 90, further comprising the step of providing for notifying the first user and the second user of the exchange.

92. A method of exchanging non-currency articles of commerce including the steps of:
permitting a first user to offer a first amount of a first non-currency article of commerce in trade for a second amount of a second non-currency article of commerce;
permitting a second user to offer a third amount of the second non-currency article of commerce for a fourth amount of the first non-currency article of commerce;
verifying that the first amount of the first non-currency article of commerce is equal to or larger than the fourth amount of the first non-currency article of commerce;
verifying that the third amount of the second non-currency article is equal to or greater than the second amount of the second non-currency article; and
providing for the execution of a trade.

93. The system of claim 92, wherein the provided for trade results in the first user receiving the second amount of the second non-currency article of commerce, the second user receiving the fourth amount of the first non-currency article of commerce, and the system retaining any difference between the first and fourth amounts of the first non-currency article of commerce and any difference between the second and third amounts of the second non-currency article of commerce.

94. The system of claim 92, further comprising the step of providing for issuance of a notice of the executed trade to the first user and to the second user.

95. A method of exchanging non-currency articles of commerce including the steps of:
accessing of an exchange system by a first user; and
offering, by the first user, a first amount of a first non-currency article of commerce in trade for a second amount of a second non-currency article of commerce, wherein the exchange system permits a second user to accept the offer of the first user.

96. The method of claim 95, wherein the offers are searchable by the second user.

97. The method of claim 95, wherein the offers are stored on a database.

98. The method of claim 95, wherein the first user and the second user each have escrow accounts with the exchange system.

99. The method of claim 95, wherein the accessing step is performed over a network.

100. A method of exchanging non-currency articles of commerce including the steps of:
accessing of an exchange system by a second user;
viewing offers from a first user to exchange a first amount of a first non-currency article of commerce for a second amount of a second non-currency article of commerce; and
accepting an offer.

101. The method of claim 100, wherein the offers are stored in a database.

102. The method of claim 100, wherein the accessing step is performed over a network.

103. The method of claim 100, wherein the first user and the second user each have escrow accounts with the exchange system.

104. The method of claim 100, wherein the offer of the first user is removed from the system when the offer is accepted by the second user.

105. A method of exchanging non-currency articles of commerce including the steps of:
receiving non-currency articles of commerce; and
providing for the non-currency articles of commerce to be associated with a first user, wherein the first user is permitted to trade the non-currency articles of commerce with other users of an exchange system.

106. The method of claim 105, wherein the providing step includes associating the non-currency articles of commerce with an escrow account.

107. The method of claim 105, wherein the providing step includes forwarding the received non-currency articles to another location.

108. The method of claim 105, wherein a record of the received non-currency articles is maintained by the exchange system.

109. A method of exchanging non-currency articles of commerce including the steps of:
transmitting a first communication of a first user, the communication offering to trade a first amount of a first non-currency article of commerce for a second amount of a second non-currency article of commerce;
transmitting a listing of offers; and
transmitting a second communication of a second user, the second communication accepting the offer of the first user.

110. The method of claim 109, further including the step of transmitting confirmation of the trade.

111. The method of claim 110, further including the steps of transmitting a third communication to identify the first user; and transmitting a fourth communication to identify the second user.

112. The method of claim 111, wherein the third communication associates the first user with an escrow account and the fourth communication associates the second user with an escrow account.

113. The method of claim 109, wherein the second amount of the second non-currency article of commerce is determined by the system.

114. A method of exchanging articles of commerce including the steps of:
accessing of an exchange system for a first user;
offering, for the first user, a first amount of a first article of commerce in trade for a second amount of a second article of commerce;
storing of the offer of the first user by the exchange system;
accessing of the exchange system for a second user;
searching of the exchange system for the second user;
accepting the offer of the first user for the second user;
transferring ownership of the first amount of the first article of commerce to the second user; and
transferring ownership of the second amount of the second article of commerce to the first user.

115. A method of exchanging articles of commerce including the steps of:
accessing of an exchange system by a first user;
offering, by the first user, a first amount of a first article of commerce in trade for a system determined second amount of a second article of commerce;
storing of the offer of the first user by the exchange system;
accessing of the exchange system by a second user;
searching of the exchange system by the second user;
accepting the offer of the first user by the second user;
transferring ownership of the first amount of the first article of commerce to the second user; and
transferring ownership of the second amount of the second article of commerce to the first user.

116. The method of claim 115, wherein the second user also transfers cash to the first user.

117. A method of exchanging articles of commerce including the steps of:
allowing a user to obtain a subscription to an exchange service environment;
allowing the user to exchange articles of commerce free from per-transaction charges within the service environment.

118. The method of claim 117, wherein the user obtains the subscription by paying a monthly fee.

119. The method of claim 117, wherein the subscription allows the user to perform a set amount of exchanges per subscription period free from per-transaction charges.

120. The method of claim 119, wherein exchanges performed during the subscription period beyond the set amount result in per-transaction charges.

121. The method of claim 117, wherein the subscription entitles the user to an unlimited number of exchanges as long as the user keeps the subscription current.

122. The method of claim 117, wherein the exchange service environment is a stock trading environment that requires a periodic subscription fee and allows unlimited trading free from per-transaction charges for the duration of the subscription period.
